(19) United States
(12) Patent Application Publication
(10) Pub. No.: US 2002/0101055 A1
(43) Pub. Date: Aug. 1, 2002

(54) Self-aligning towing assembly with breakaway guide housing

(76) Inventor: M. Timothy Warren, Savannah, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/779,908

(22) Filed: Feb. 1, 2001

(51) Int. Cl. B60D 1/00

(52) U.S. Cl. 280/477; 280/504

(57) ABSTRACT

A towing assembly for connecting a first vehicle with a second vehicle includes a hitch frame for mounting to one vehicle and a coupler assembly for mounting to the other vehicle. A coupler guide housing includes a receiver pivotably mounted to the hitch frame. The receiver has a receiver opening. A plurality of guide walls are mounted to the receiver and converge toward the receiver opening.

The coupler assembly has a coupler element at one end. The coupler element is configured to be received through the receiver opening and into the receiver. The towing assembly is operable to couple the coupler element within the receiver. A latch mechanism is normally operable to latch the coupler guide housing in an aligned position relative to the hitch frame. when a rotational force greater than a predetermined rotational force is exerted on the coupler guide housing, the latch mechanism is operable to unlatch the coupler guide housing to permit it to pivot with respect to the hitch frame. The ability of the coupler guide housing to break free to pivot under excessive force helps prevent damage to the towing assembly, the towing vehicle, and the towed vehicle.

### FIELD OF THE INVENTION

This invention relates generally to towing assemblies, and more specifically to a towing assembly that has a hitch including a funnel-shaped housing to guide the coupler into proper alignment with a hitch pin.

### BACKGROUND OF THE INVENTION

One of the more common trailer hitch configurations uses a ball and socket arrangement to couple a trailer or other towed vehicle to a towing vehicle. A typical ball and socket hitch comprises a ball hitch component extending from a towing vehicle, and a socket or coupler component at the forward end of a tongue extending from a towed vehicle. When the ball component is aligned with the socket component, the ball and socket components can be coupled together to hitch the towed vehicle to the towing vehicle.

Aligning the components so that the ball hitch component engages the coupler socket component of the towed vehicle can be problematic. Typically, a towing vehicle equipped with a ball hitch slowly backs up towards a towed vehicle equipped with a socket or coupler component. Manual intervention is then required to guide the socket down over the ball hitch. In some cases, the tongue of the towed vehicle may physically ram into the towing vehicle, causing damage to the vehicles or to the hitch components. In other cases, the components physically ram into each other causing damage to the ball and socket hitch components. In even a best case scenario, coupling the conventional ball and socket hitch can be inconvenient and time consuming.

Attempts have been made to provide a trailer hitch assembly which physically guides the components into alignment to facilitate coupling and to minimize possible damage to the trailer hitch and vehicles. One such design, shown in my U.S. Pat. No. 5,941,551, includes a coupler guide comprised of guide walls attached to the hitch assembly of a towing vehicle. When the coupler at the forward end of a tongue attached to the towed vehicle engages the guide walls, the coupler is funneled toward a receiver in the central portion of the guide. When the coupler enters the receiver, the shape of the receiver walls automatically directs the coupler into alignment with a locking pin, which couples the hitch to the coupler to secure the towed vehicle to the towing vehicle.

While the design disclosed in the aforementioned U.S. Pat. No. 5,941,551 provides significant advantages, the guide walls present new challenges. If the towing vehicle backs toward the towed vehicle too quickly such that the tongue of the towed vehicle strikes an outer portion of one of the guide walls, the torque can damage the coupler guide, the hitch, or the vehicles. In other cases the towed vehicle may “jackknife” with respect to the towing vehicle, causing the tongue of the coupler to strike the coupler guide. The force exerted by the coupler against the coupler guide can damage the coupler, the hitch, or both, and can even cause damage to the towing vehicle.

### SUMMARY OF THE INVENTION

The present invention addresses the problems described above by providing a mounting arrangement for the coupler guide which minimizes or prevents damage to a trailer hitch and coupler, and to vehicles using the trailer hitch or coupler. Furthermore, the present invention maintains the advantages of an improved self-aligning towing assembly that is self-connecting and allows for maximum horizontal and vertical movement of the towed vehicle relative to the towing vehicle.

Generally described, the invention is a towing assembly for connecting a towed vehicle to a towing vehicle. The towing assembly includes a hitch assembly which mounts to the towing vehicle and a coupler assembly that mounts to the towed vehicle. The hitch assembly includes a coupler guide consisting of angled walls which funnel the coupler toward an opening in the central portion of the coupler guide. The opening leads to a receiver which is configured to guide the coupler into alignment with a hitch pin. The coupler guide is pivotably mounted to the hitch assembly. A spring-loaded pin retains the coupler guide in a normal position. Under normal circumstances, when a force smaller than a predetermined force is exerted against the walls of the coupler guide, the pin will retain the coupler guide in its normal position. However, when a torque of predetermined magnitude is exerted against the coupler guide housing, such as by the coupler striking the coupler guide too hard, by the coupler striking the outermost portion of the coupler guide, or by the towed vehicle jackknifing, the force of the spring-loaded pin is overcome, and the coupler guide breaks free to pivot with respect to the coupler. Thus damage to the hitch assembly, the coupler, and the towed vehicles is prevented or minimized.

That the invention improves over the prior art and accomplishes the advantages described above will become apparent from the following detailed description of the exemplary embodiments and the appended drawings and claims.

### BRIEF DESCRIPTION OF THE DRAWINGS

FIG. 1 is an exploded perspective view of a towing apparatus according to a first embodiment of the present invention.

FIG. 2 is a partially exploded side view of a hitch assembly of the towing apparatus of FIG. 1 with the hitch frame cut away to reveal interior detail.

FIG. 3 is a side view of the hitch assembly and the coupler assembly with the hitch frame cut away.

FIG. 4 is an exploded side view of the pin subassembly of the towing apparatus of FIG. 1.

FIG. 5 is a top view of the towing apparatus of FIG. 1 with a coupler guide housing in an aligned position with respect to the hitch frame.

FIG. 6 is a side view of the towing apparatus of FIG. 1 showing the coupler assembly coupled to the hitch assembly.

FIG. 7 is a top view of coupler assembly and hitch assembly of FIG. 6.

FIG. 8 is a top view illustrating the coupler assembly in a “jack-knifed” position with respect to the hitch assembly, with phantom lines showing the coupler guide housing in a “break away” position with respect to the hitch frame.

FIG. 9 is a top view illustrating a coupler assembly striking a coupler guide housing off-center, with the coupler guide housing pivoted to a “break away” position with respect to the hitch frame.

FIG. 10 is a side view of a mounting bracket of a second embodiment of the present invention.

FIG. 11 is a top view of the mounting bracket of FIG. 10.

FIG. 12 is a side cutaway view of the mounting bracket taken along line 12-12 of FIG. 11, showing a ball and spring exploded from the mounting bracket.

FIG. 13 shows the mounting bracket of FIG. 12 with the ball and spring mounted within a bore in the mounting bracket.

FIG. 14 is a top cutaway view taken along line 14-14 of FIG. 11, showing the ball and spring mounted within the bore of the mounting bracket.

FIG. 15 is a side view of a hitch frame of the second embodiment showing the mounting bracket of FIGS. 10-14 exploded therefrom.

FIG. 16 is a side view of the hitch frame of FIG. 15 with the mounting bracket of FIGS. 10-14 mounted thereto.

FIG. 17 is a top view of the hitch frame and mounting bracket assembly of FIG. 16.

### DETAILED DESCRIPTION OF THE DISCLOSED EMBODIMENTS

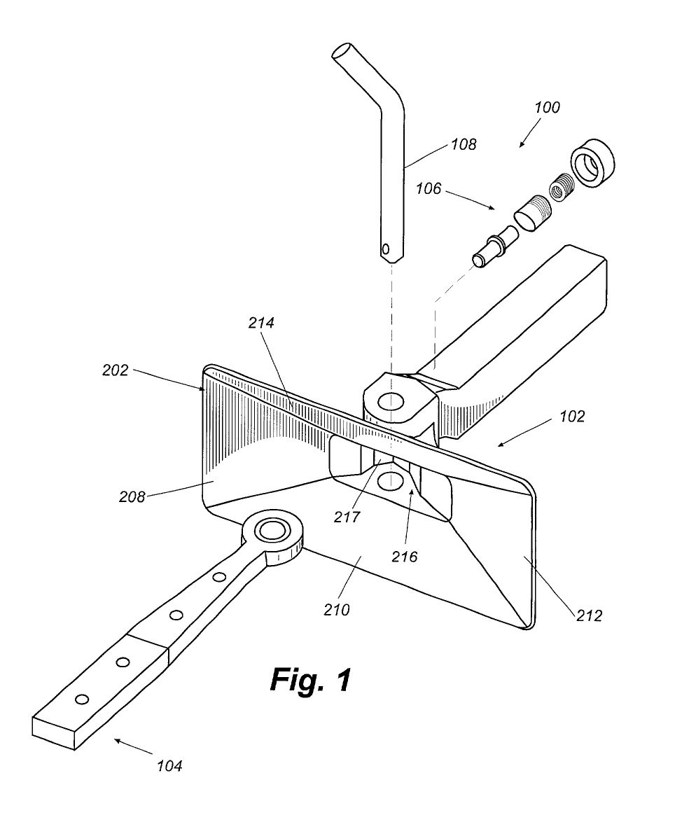

Referring now in more detail to the drawings, in which like numerals indicate like elements throughout the several views, FIGS. 1-9 show a first embodiment 100 of a towing assembly. As seen in FIG. 1, the towing assembly 100 includes a hitch assembly 102 and a coupler assembly 104. The hitch assembly 102 includes a retainer pin subassembly 106. When aligned, the hitch assembly 102 and coupler assembly 104 can connect together so that the towing assembly 100 can connect a first vehicle with a second vehicle. A hitch pin 108 secures the coupler assembly 104 to the hitch assembly 102, as will be more fully explained below.

The hitch assembly 102 further includes a coupler guide housing 202. The coupler guide housing 202 has four guide walls 208, 210, 212, and 214 which converge rearward into a receiver opening 216. The receiver opening 216 is sized to receive the forward end of the coupler assembly 104. In the disclosed embodiment the outer perimeter formed by the four guide walls 208, 210, 212, and 214 is rectangular in shape. However, it will be understood that the coupler guide housing 202 may include a greater or lesser number of guide walls, and that the perimeter formed by the guide walls may be shapes other than rectangular.

The coupler guide housing 202 of the disclosed embodiment can be manufactured from 8 gauge, AISI 1040 steel. The height of the coupler guide housing 202 of the disclosed embodiment is approximately 5.6 inches, and the width is approximately 14.9 inches. The guide walls 208, 210, 212, and 214 extend approximately 4.1 inches back from the outer perimeter to the receiver opening 216. The receiver opening 216 of the disclosed embodiment is approximately 2.0 inches in height and approximately 3.5 inches wide. The rear portion of the coupler guide housing 202 comprises a receiver 217 which receives the forward end of the coupler assembly 104 therewithin. The receiver 217 can be rounded to approximately a 1.5 inch radius from the guide walls 208, 210, 212, and 214. Preferably the upper and lower surfaces of the receiver 217 are flat.

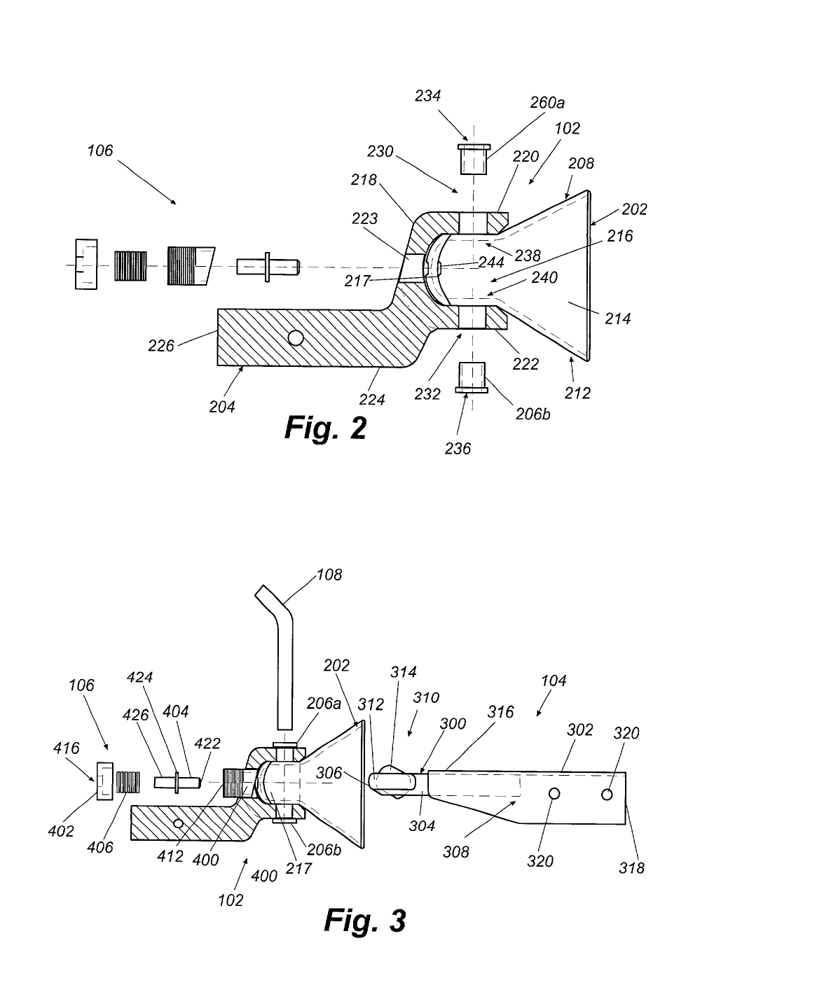

Referring now to FIG. 2, the hitch assembly 102 includes a hitch frame 204. The hitch frame 204 includes a longitudinal leg 224, the forward end 226 of which supports a mount (not shown) operable to connect the hitch frame 204 to a towing vehicle. At the rearward end of the longitudinal leg 224 is an upright leg 218. Upper and lower arms 220, 222 extend rearward in spaced-apart relation from the upright leg 218. A horizontal bore 223 is formed through the upright leg 218 of the hitch frame 204 intermediate the upper and lower arms 220, 222.

The hitch frame 204 is shaped to support the coupler guide housing 202 in position relative to a towing vehicle. The receiver 217 of the coupler guide housing 202 is received between the arms 220, 222. A countersink 244 is formed in the wall of the receiver 217 of the coupler guide housing 202 coaxial with the horizontal bore 223. In the disclosed embodiment, the countersink 244 is approximately 0.4 inches in diameter and 0.3 inches in depth with approximately 90 degree walls.

Holes 230, 232 machined through the upper arm 220 and lower arm 222, respectively, align with corresponding holes 238, 240 in the receiver 217 of the coupler guide housing 202. Bushings 206a, 206b are press-fitted into the holes 230, 232 in the upper and lower arms 220, 222 of the hitch frame 204, and extend into the corresponding holes 238, 240 in the receiver 217 of the coupler guide housing 202. In this manner the coupler guide housing 202 is pivotably mounted to the hitch frame 204.

The bushings 206a, 206b have machined longitudinal holes 234, 236 sized to receive the hitch pin 108 therethrough. In the disclosed embodiment, the bushings 206a, 206b are approximately 1.0 inches in length, with a head diameter of approximately 1.1 inches, and a body diameter of approximately 1.2 inches. The longitudinal holes 234, 236 machined through the bushings 206a, 206b measures approximately 0.9 inches in diameter. The corresponding holes 230, 232, 238, 240 in the hitch frame 204 and the receiver 217 are approximately 1.2 inches in diameter.

Referring further to FIG. 3, the coupler assembly 104 includes a coupler 300 and a channel member 302. The coupler 300 includes an arm 304 with a forward end 306 and a rearward end 308. The arm 304 includes a double annulus coupler element 310 comprising an annular shaped outer ring 312 formed in the forward end 306 of the arm. An annular shaped inner ring 314 is mounted for orbital movement within the outer ring 312, similar to the double annulus connector head shown and described in U.S. Pat. No. 5,941,551, entitled “EZ Hitch”, issued Aug. 24, 1999, which is commonly owned and assigned, the content of which is incorporated herein by reference. The coupler element 310 is configured to fit through the receiver opening 216 of the coupler guide housing 202 and to fit closely within the receiver 217.

The channel member 302 of the coupler assembly 104 is a channel-shaped piece that connects to the tube end 308 of the hitch arm 304 to permit the hitch coupler 300 to be connected to a towed vehicle (not shown). The channel member 302 defines a tube end 316 and a mount end 318, the tube end 316 adjacent to the tube end 308 of the hitch arm 304, and the mount end 318 to be connected to the vehicle. A series of holes 320 machined in the channel member 302 permit the formed channel 302 to be connected to the towed vehicle.

In the disclosed embodiment, the channel member 302 is fabricated from AISI 1040 steel channel and measures approximately 12.0 inches in length, approximately 3.5 inches in width, and approximately 3.0 inches in height. A series of three vertically oriented holes 320 are machined through the top portion of the formed channel 302. Each hole 320 can be approximately 0.6 inches diameter and spaced on approximate 3.0 inch centers, approximately 1.8 inches from the mount end 318 of the formed channel 302. The sides of the formed channel 302 taper away from the mount end 318, leaving the opposing approximately 2.1 inches wide and approximately 1.5 inches in height. A series of two horizontally oriented holes 320 can be machined through the sides of the formed channel 302. Each hole 320 can be approximately 0.6 inches in diameter and spaced approximately 3.1 inches apart, approximately 1.4 inches from the mount end 318.

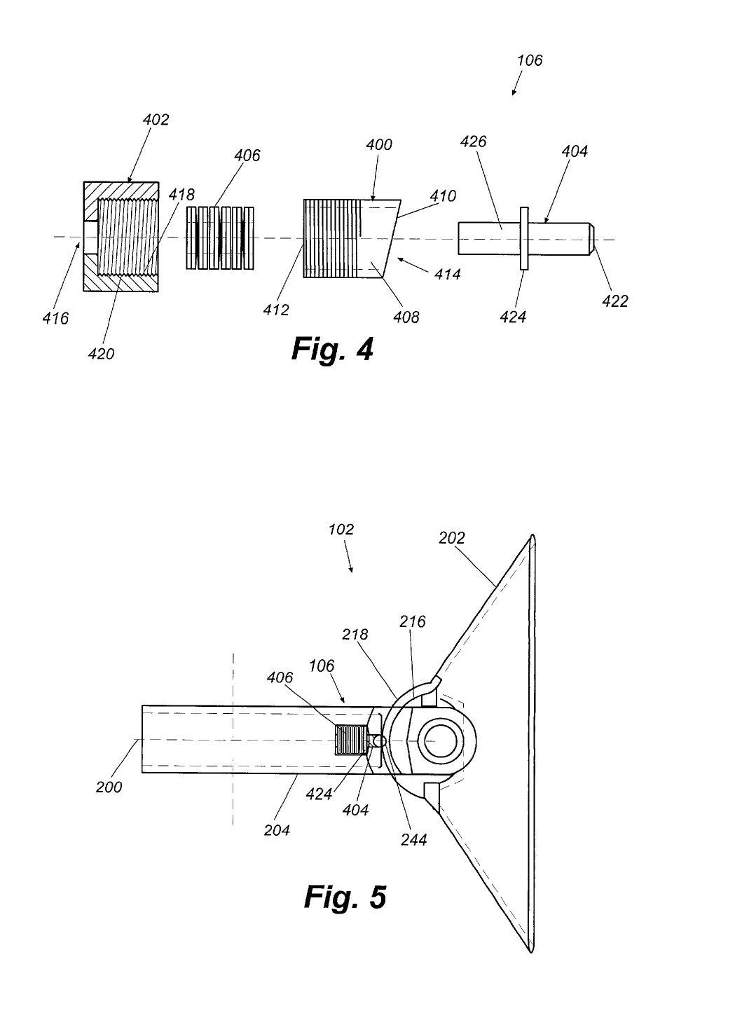

Referring now to FIG. 4, the retainer pin assembly 106 includes a sleeve 400, an end cap 402, a collared pin 404, and a spring 406. The sleeve 400 includes a cylindrical body 408 with a beveled end 410 and an externally threaded end 412. The cylindrical body 408 of the sleeve 400 has a longitudinal bore 414 formed therethrough. The end cap 402 is a conventional pipe cap with a bore 416 machined through the end portion and a counterbore 418 machined inside the end cap 402. The hole 416 is sized to receive the shaft of the collared pin 404. The opening 418 is internally threaded and is sized to screw onto the externally threaded end 412 of the sleeve 400.

The collared pin 404 includes a chamfered end 422, an annular collar 424, and a pin body 426. The collar 424 provides a seat for the spring 406 to contact the pin 404 to apply an axial force to the pin.

The spring 406 is a conventional helical spring having an inner diameter which is larger than the outer diameter of the pin body 426 but smaller than the outer diameter of the collar 424. The spring 406 is thus configured to fit around the pin body 426 and bear against the collar 424 of the pin 404. The outer diameter of the spring 406 is sized to seat within the opening 416 of the end cap 402.

In the disclosed embodiment the collared pin 404 measures approximately 0.5 inches in diameter and approximately 2.3 inches in length. The collar 424 is spaced approximately 1.1 inches from the chamfered end 422 of the pin 404. The collar 424 is approximately 0.1 inches in width measured parallel to the pin body 426, and measures approximately 0.9 inches in diameter. The chamfered end 422 of the pin 404 has an approximately 45 degree chamfer, offset approximately 0.073 inches from the end. The pre-threaded cylinder 400 is manufactured from approximately 1 inch carbon steel tubing, and measures approximately 1.3 inches in length from the threaded end 412 to the angled end 414. The angled end 414 of the sleeve 400 is machined to approximately a 75 degree angle. Suitable threads machined on the outer diameter of the threaded end 412 are 1″-12 UNF. A suitable spring 406 is a Belleville spring, Model #B1000-073-S, manufactured by Belleville Inc. A suitable end cap 402 can be a conventional cap for 1″-12 UNF threads on approximately a 9/16″ diameter.

The retainer pin assembly 106 mounts to the hitch frame 204 as follows. The sleeve 400 is fitted into the hole 223 in the upright leg 218 of the hitch frame 204, as shown in FIG. 3. The sleeve 400 is welded or otherwise secured within the hole 223 in the hitch frame 204. The chamfered forward end 422 of the collared pin 404 is inserted into the sleeve 400 and advanced until the forward end of the pin rests in the countersink 244 in the adjacent face of the receiver 217 of the coupler guide housing 202. Next the spring 406 is advanced over the rearward end of the collared pin 404 and advanced over the pin body 426 until the forward end of the spring rests against the collar 424. The end cap 402 is then screwed onto the rear end 412 of the sleeve 400. The rearward end of the spring 406 rests against the base of the counterbore 418 of the end cap 402. As the end cap 402 is tightened down, the spring 406 is compressed, exerting a longitudinal force against the pin 404 which presses the forward end of the pin into the countersink 244 in the receiver 217 of the coupler guide housing 202. If the end cap 402 is advanced sufficiently far, or if the pin 404 is displaced rearward, the back end of the pin will project through the opening 416 in the end cap.

With the retainer pin assembly 106 thus mounted to the hitch frame 204, the spring-loaded pin 404 engages the countersink 244 to lock the coupler guide housing 202 and receiver opening 216 in an aligned position relative to the hitch frame 204.

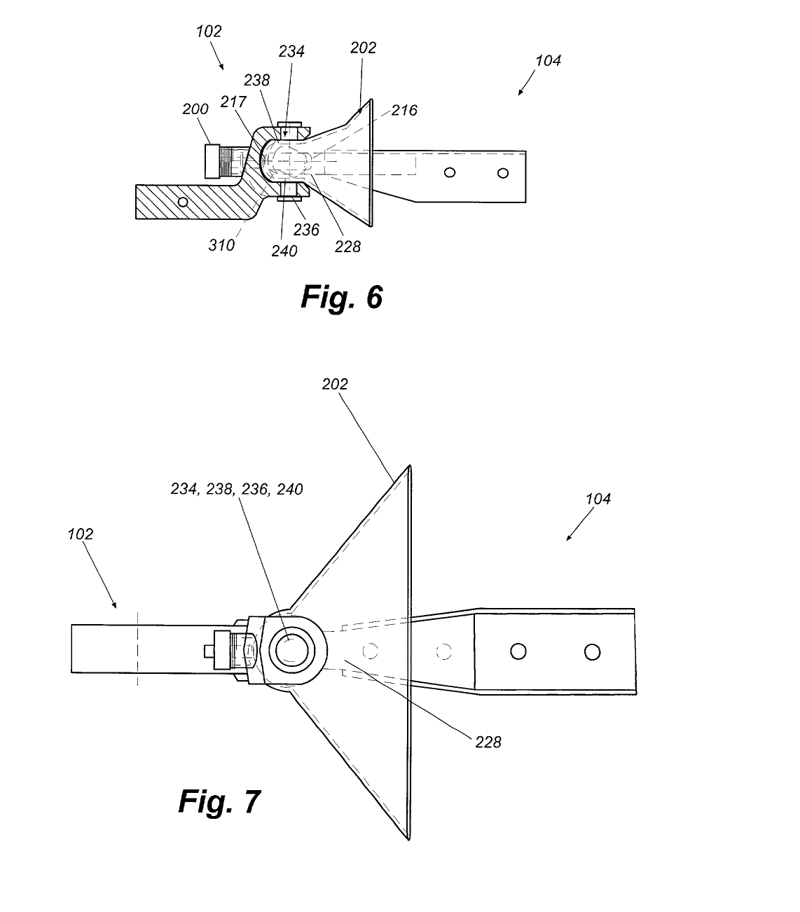

Referring now to FIGS. 6 and 7, to connect the hitch assembly 102 with the coupler assembly 104, the coupler assembly is positioned relative to the coupler guide housing 202 so that the coupler element 310 is received through the receiver opening 216 and into the receiver 217. The inner walls of the receiver 217 are configured to guide the coupler element 310 into a position such that the hole through the inner ring 314 of the coupler element 310 is vertically aligned with the upper and lower holes 238, 240 of the receiver 217. When the holes 238, 240 are aligned with the hole through the inner ring of the coupler element 310, the hitch pin 108 can be inserted into the top bushing hole 234 so that the pin 108 extends through the top receiver opening hole 238. The hitch pin 108 further extends through the hole in the inner ring 314 of the coupler element 310, through the bottom receiver opening hole 240, and into the lower bushing hole 236. When the hitch pin 108 is secured within the holes 234, 236, 238, 240 and the inner ring of the coupler element 310, the trailer hitch assembly 100 is operable to provide an apparatus for pulling a towed vehicle behind a towing vehicle.

As described above with respect to FIGS. 4 and 5, the retainer pin assembly 106 is in a pre-tensioned or pre-loaded state. When the coupler guide housing 202 is positioned in an aligned position relative to the hitch frame 204 along the connection axis 200, the chamfered end 422 of the pin 404 engages the countersink 244 in the outer portion of the receiver opening 216. When the pin 404 engages the countersink 244, the pre-tensioned state of the pin 404 rigidly holds the coupler guide housing 202 in a position relative to the hitch frame 204 along the connection axis 200.

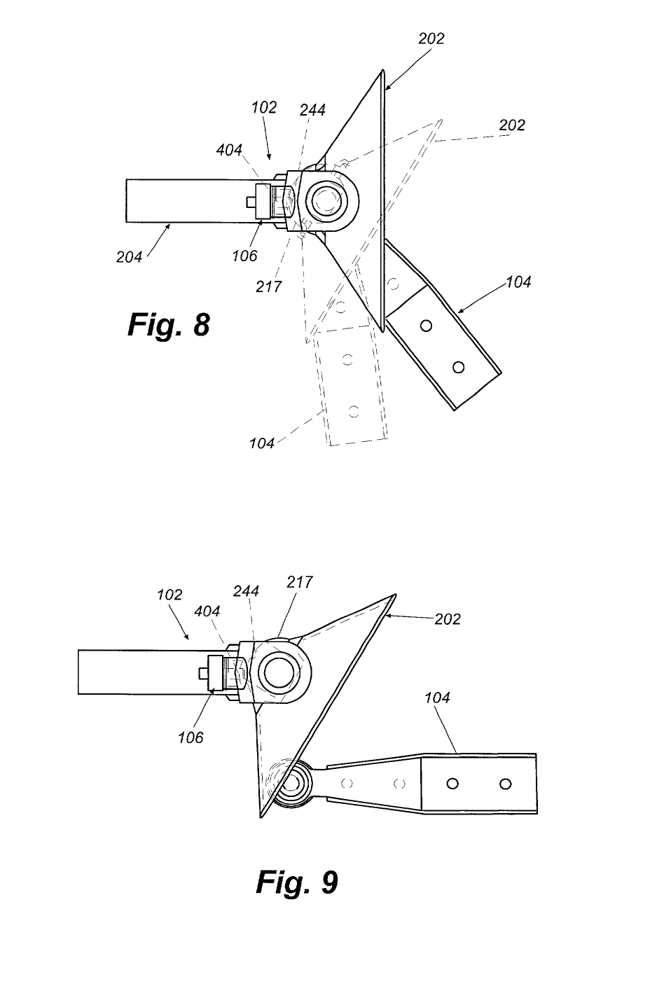

FIG. 8 is a top view of the receiver coupling assembly 102 and the coupler hitch assembly 104 in a “jack-knife” position, i.e., the towed vehicle has jack-knifed with respect to the towing vehicle. If the coupler assembly 104 pivots sufficiently far that it strikes the outer edge of the coupler guide housing 202, the coupler assembly applies a force to the coupler guide housing. If the rotational force exerted against the coupler guide housing 202 by the coupler assembly 104 exceeds the pre-loaded force of the retainer pin assembly 106, then the collared pin 404 disengages the countersink 244 in the adjacent wall of the receiver 217, and the coupler guide housing 202 pivots or “breaks away” with respect to the hitch frame 204, as shown by the phantom lines in FIG. 8. When the coupler guide housing 202 pivots in response to a predetermined force, potential damage to the assemblies 102, 104, the towing vehicle, or the towed vehicle can be minimized or prevented when the coupler guide housing 202 breaks away or pivots.

FIG. 9 illustrates what happens when a coupler assembly 104 forcefully strikes an outer edge of the coupler guide housing 202 during the coupling procedure. If the rotational force exerted by the coupler assembly 104 against the coupler guide housing 202 becomes greater than the pre-tensioned or pre-loaded force of the retainer pin assembly 106, then the collared pin 404 disengages the countersink 244 in the outer portion of the receiver opening 216. The coupler guide housing 202 is now free to pivot or “break away” with respect to the hitch frame 204 avoiding potential damage to the assemblies 102, 104, the towing vehicle, or the towed vehicle.

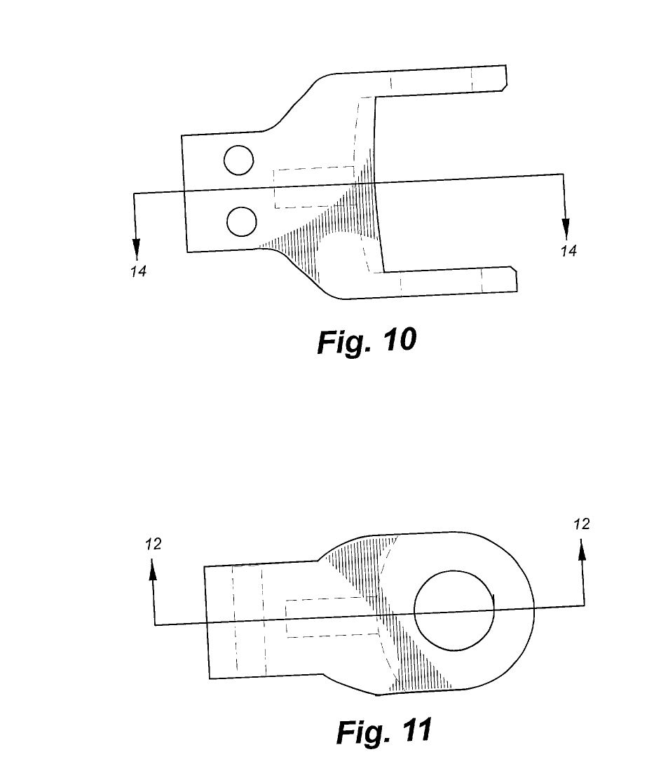

A second embodiment of a hitch assembly is illustrated in FIGS. 10-17. Referring first to FIGS. 10 and 11, a hitch mounting bracket 500 includes a main body portion 502. Upper and lower arms 504, 506 extend forward from the upper and lower ends of the main body portion 502 in parallel, spaced-apart relation. The mounting bracket 500 is configured to accept the receiver 217 of the coupler guide housing 202 (see, e.g., FIGS. 2, 3) hereinabove described. Vertical bores, 510, 512 are formed in the upper and lower arms 504, 506 of the hitch mounting bracket 500. The bores, 510, 512 are dimensioned to receive the bushings 206A, 206B (again, see, e.g., FIGS. 2, 3) to pivotably mount the coupler guide housing 202 to the hitch mounting bracket 500 in substantially the same manner as described above with respect to the first embodiment. A pair of transverse bores 516 are formed in a rearward portion of the main body portion 502, the function and purpose of which will be explained below.

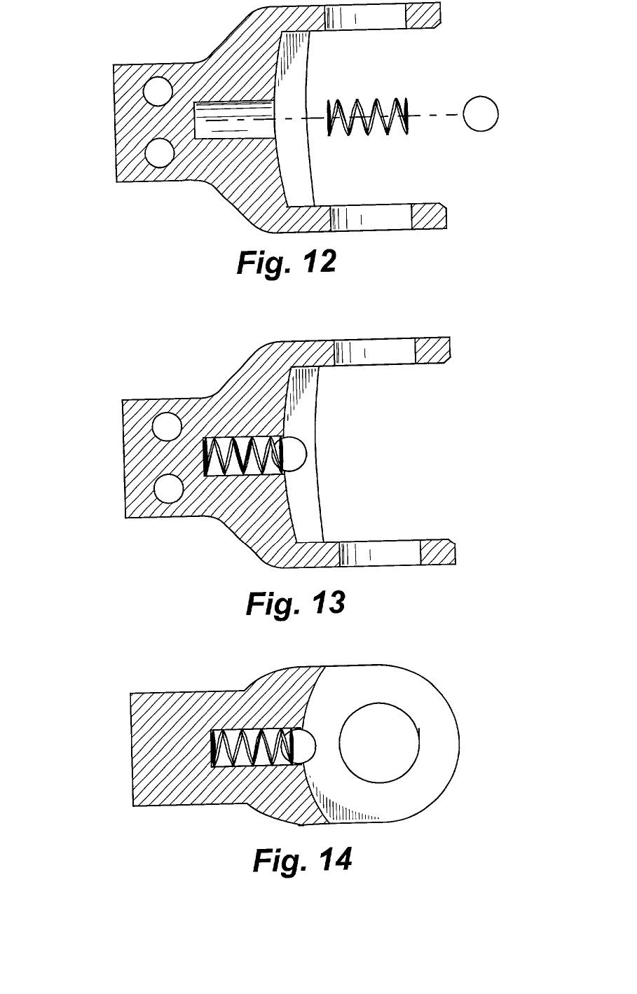

Referring now to FIGS. 12-14, a bore 520 is formed in the forward face 522 of the main body portion 502 of the hitch mounting bracket 500. The bore 520 is configured to receive a coil spring 524 therewithin. A steel ball 526 rests in the forward end of the coil spring 524.

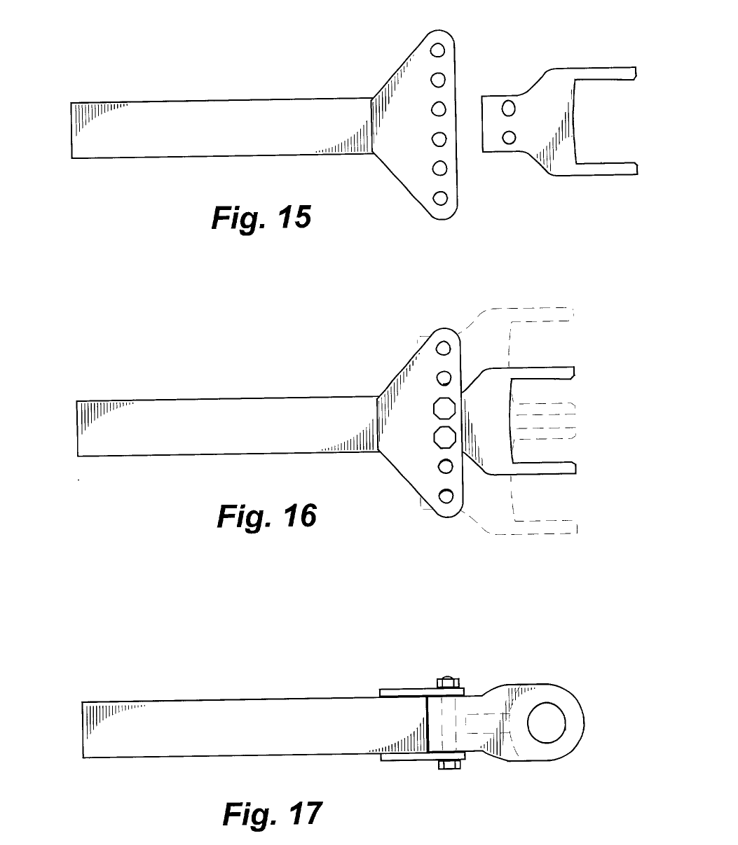

Referring now to FIGS. 15-17, a hitch frame 530 includes a longitudinal leg 532. A pair of spaced-apart flanges 534 extending forward from each lateral edge 536 of the longitudinal leg 532. Each flange includes a plurality of bores 540. Each of the bores 540 is spaced apart from the adjacent bore 540 by an amount equal to the spacing between the transverse bores 516 of the hitch mounting bracket 500. The flanges 534 are configured to receive the rearward portion of the main body portion 502 of the hitch mounting bracket 500 therebetween.

As can be seen in FIG. 16, the hitch mounting bracket 500 is mounted to the hitch frame 530 by inserting the rearward portion of the mounting bracket between the flanges 534 of the hitch frame. The transverse bores 516 in the hitch mounting bracket 500 are aligned with two of the bores 540 and the flanges 534 of the hitch frame 530. By selecting which two of the bores 540 with which to align the bores 516 in the hitch mounting bracket 500, the hitch mounting bracket 500 can be mounted at any of a number of locations, some of which are illustrated in phantom lines in FIG. 16. Thus, some degree of control over the height of the hitch mounting bracket 500 is provided. The hitch mounting bracket 500 is secured to the hitch frame 530 by inserting a bolt 544 through a hole 540 in one flange 534, through the transverse bore 516 in the hitch mounting bracket 500, and through the corresponding hole 540 in the opposite flange 534. A nut 546 is threaded onto the end of each bolt 544 to complete the connection.

The trailer hitch of the second embodiment of FIGS. 10-17 is functionally similar to the trailer hitch of the first embodiment of FIGS. 1-9, with the following differences. First, whereas the functions of the hitch frame 204 and mounting brackets 220, 222 of the first embodiment are provided in a single unitary component, these functions are provided by two different components 500, 530 in the trailer hitch of the second embodiment. By providing the hitch frame 530 and the hitch mounting bracket 500 as two separate components, the height of the mounting bracket with respect to the hitch frame can be modified to accommodate differences in various trailers.

The second difference between the two embodiments concerns the mechanism by which the coupler guide housing 202 is releaseably retained in place. Whereas the first embodiment employs a longitudinal pin 404 whose beveled forward end 422 engages the recess 244 in the rearward end of the coupler guide housing 202, the second embodiment of the trailer hitch employs a steel ball bearing 526 which rests in the forward end of a spring 524 and is urged forward by the spring into engagement with the recess 244 in the rearward end of the coupler guide housing. The arrangement employed by the second embodiment is simpler, less expensive to manufacture, and easier to assemble than the corresponding elements of the first embodiment. On the other end, the spring-and-ball arrangement employed by the second embodiment does not provide any mechanism for increasing or decreasing the spring tension which governs the force which must be exerted against the coupler guide housing 202 before it will break away and pivot with respect to the hitch frame. To change the force exerted by the ball 526, the spring 524 can be swapped out for a spring of a different strength. In the alternative, shims can be inserted into the base of the bore 520 to shorten the effective length of the spring 524, thereby causing it to exert a greater force.

The coupler guide housing 202 is mounted between the upper and lower arms 504, 506 of the hitch mounting bracket 500 in the same manner as described above with respect to the first embodiment of FIGS. 1-9. The coupler guide housing 202 is rotatably affixed to the hitch mounting bracket 500 by means of bushings (see bushings 206A and 206B in FIG. 3), and a coupler assembly 104 is coupled to the hitch assembly by means of a hitch pin 108 (see, e.g., FIG. 3).

In view of the foregoing, it will be appreciated that the invention provides an apparatus for a towing vehicle to tow a towed vehicle. Furthermore, the invention provides a breakaway feature that prevents or minimizes damage to the apparatus, towing vehicle, and towed vehicle if a misalignment event occurs. It should be understood that the foregoing relates only to the exemplary embodiments of the present invention, and that numerous changes may be made therein without departing from the spirit and scope of the invention as defined by the following claims.

What is claimed is:

1. A towing assembly for connecting a first vehicle with a second vehicle, comprising:
a hitch frame, said hitch frame including means for connecting said hitch frame to a first vehicle;
a coupler guide housing comprising a receiver pivotably mounted to said hitch frame, said receiver having a receiver opening, and said coupler guide housing further comprising a plurality of guide walls mounted to said receiver and converging toward said receiver opening;
a coupler assembly, said coupler assembly including means for connecting a first end of said coupler assembly to a second vehicle, and said coupler assembly further comprising a coupler element at a second end of said coupler assembly opposite said first end, said coupler element being configured to be received through said receiver opening and into said receiver, said towing assembly being operable to couple said coupler element within said receiver; and
a latch mechanism normally operable to latch said coupler guide housing in an aligned position relative to the hitch frame, and said latch mechanism further being operable when a rotational force greater than a predetermined rotational force is exerted on said coupler guide housing to permit said coupler guide housing to pivot with respect to said hitch frame.

2. The towing assembly of claim 1, wherein the coupler element is a double annulus connector head with an annulus shaped outer ring and an annulus shaped inner ring received within the outer ring for orbital movement with respect thereto.

3. The towing assembly of claim 1, wherein said latch mechanism comprises a pin movably mounted to said hitch frame and a spring for exerting an axial force against said pin, wherein said receiver comprises a recess, and wherein said spring-loaded pin further comprises a tip normally operative to engage said recess in said receiver to latch said coupler guide housing in an aligned position relative to the hitch frame.

4. The towing assembly of claim 3, wherein said spring exerts an axial force on said pin sufficient to maintain said tip of said pin in engagement with said recess until a rotational force greater than said predetermined rotational force is exerted on said coupler guide housing

5. The towing assembly of claim 4, wherein said pin comprises an annular collar, wherein said towing assembly further comprises a sleeve having an axial bore and being mounted to said hitch frame in axial alignment with said recess in said receiver, wherein said pin is slidably mounted within said bore of said sleeve, wherein an end cap is mounted to an end of said sleeve remote from said receiver, and wherein said spring comprises a coil spring fitted around said pin, one end of said coil spring bearing against said end cap, and the other end of said spring bearing against said annular collar of said pin.

6. The towing assembly of claim 5, wherein said end cap is threadingly secured to said end of said sleeve remote from said receiver, wherein said coil spring is compressed between said end cap and said annular collar of said pin, and wherein said axial force exerted by said spring can be adjusted by advancing or withdrawing said threaded end cap with respect to said sleeve.

7. The towing assembly of claim 1, wherein said coupler element further comprises a spring-receiving bore formed therein, wherein said latch mechanism comprises a spring residing within said spring-receiving bore and an engagement element biased outwardly by said spring, wherein said receiver comprises a recess, and wherein said engagement element is normally operative to engage said recess in said receiver to latch said coupler guide housing in an aligned position relative to the hitch frame.

8. The towing assembly of claim 7, wherein said engagement element comprises a sphere.

9. The towing assembly of claim 1, wherein said coupler assembly comprises:
a frame for connecting a first end of said coupler assembly to a second vehicle, said frame having a flange formed at a rearward end thereof; and
a hitch mounting bracket mounted to said flange of said frame, said hitch mounting bracket being configured to pivotably mount said coupler guide housing thereto.

10. The towing assembly of claim 9, wherein said flange further comprises means by which said hitch mounting bracket can be mounted at any of a plurality of vertically spaced locations with respect to said flange, whereby the height of said hitch mounting bracket is adjustable.
